(19) United States
(12) Patent Application Publication
(10) Pub. No.: US 2022/0339943 A1
(43) Pub. Date: Oct. 27, 2022

(54) Ink Package

(71) Applicant: Seiko Epson Corporation, Tokyo (JP)

(72) Inventor: Shugo HATTORI, Shiojiri (JP)

(21) Appl. No.: 17/725,584

(22) Filed: Apr. 21, 2022

(30) Foreign Application Priority Data
Apr. 22, 2021 (JP) 2021-072401

(51) Int. Cl. B41J 2/175; C09D 11/037

(52) U.S. Cl. CPC B41J 2/17513; C09D 11/037

(57) ABSTRACT

An ink bottle includes an ink jet ink composition and a storage section containing the ink jet ink composition. The ink bottle contains a substance having a thermal conductivity of 0.29 W/mK or less, and the ink jet ink composition contains at least one colorant having a coumarin backbone and also contains water.

The present application is based on, and claims priority from JP Application Serial Number 2021-072401, filed Apr. 22, 2021, the disclosure of which is hereby incorporated by reference herein in its entirety.

### BACKGROUND

### 1. Technical Field

The present disclosure relates to an ink package.

### 2. Related Art

Ink jet recording is rapidly growing in different fields as it enables high-definition image recording with a simple system, for example compared with previous analog printers. Against this background various studies are ongoing on themes such as ejection stability. JP-A-2016-190932, for example, discloses a yellow ink composition that contains a fluorescent dye having a coumarin structure.

The ink jet ink composition (hereinafter also referred to as ink composition) described in JP-A-2016-190932, however, is disadvantageous in that it is not very stable when stored. To be more specific, ink compositions that contain a dye having a coumarin structure are not very stable when stored, and the form of the container for the ink, or the ink package, also has impact on their storage stability. Insufficient storage stability affects the ejection of the ink from an ink jet head as it means the ink produces contaminants in itself easily. There is a need for an ink package in which ink is more stable when stored.

### SUMMARY

An ink package includes an ink jet ink composition and a storage section containing the ink jet ink composition. The ink package contains a substance having a thermal conductivity of 0.29 W/mK or less, and the ink jet ink composition contains at least one colorant having a coumarin backbone and also contains water.

### BRIEF DESCRIPTION OF THE DRAWINGS

FIG. 1 is a schematic cross-sectional view of an ink bottle 10 according to an embodiment.

FIG. 2 is a schematic cross-sectional view of the ink bottle 10.

FIG. 3 is a schematic cross-sectional view of an alternative ink bottle 110.

FIG. 4 is a schematic cross-sectional view of an alternative ink bottle 120.

FIG. 5 is a schematic cross-sectional view of an alternative ink bottle 130.

FIG. 6 is a schematic cross-sectional view of an alternative ink bottle 140.

FIG. 7 is a schematic perspective view of an alternative ink bottle 150.

### DESCRIPTION OF EXEMPLARY EMBODIMENTS

The following describes embodiments of the present disclosure. The following embodiments are descriptions of examples of the disclosure. The disclosure is never limited to these embodiments and includes variations implemented within the gist of the disclosure. Not all the elements, features, or configurations described below are essential to the disclosure.

### 1. Ink Package

The following describes an ink bottle as an example of an ink package according to an embodiment. The ink bottle in this embodiment may be an ink bottle attached to a recording apparatus, such as an ink jet printer, or may be a refill ink bottle, which is a temporary storage of an ink jet ink composition for refilling the recording apparatus. An ink bottle is not the only possible form of an ink package according to an aspect of the present disclosure. Forms like an ink pack, an ink cartridge, an ink box, and an ink pouch are also possible.

The ink bottle contains an ink jet ink composition (hereinafter also referred to as an ink composition). The ink bottle may also contain gas. The ink bottle includes a container body, a spout, and a seal. The following describes the container body, spout, and seal of the ink bottle first, and then proceeds to the contents, such as the ink jet ink composition and gas.

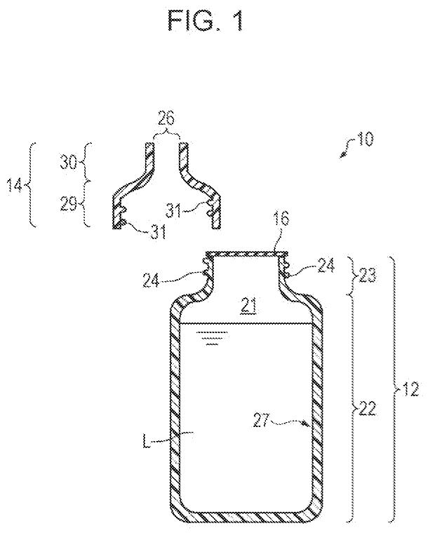

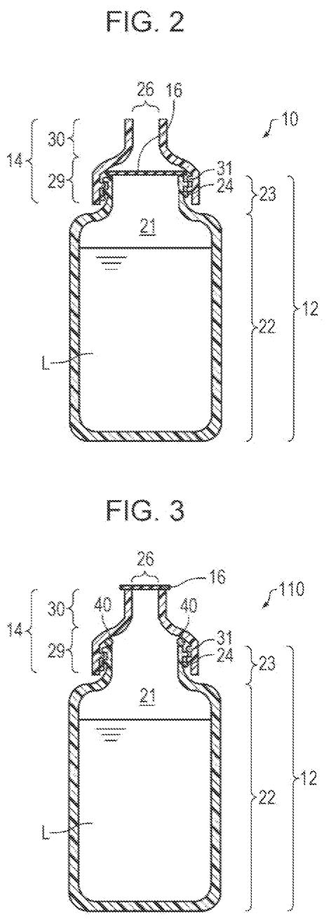

FIGS. 1 and 2 are schematic cross-sectional views of an ink bottle 10 according to this embodiment. In FIG. 1, the spout 14 has been removed from the container body 12. In FIG. 2, the spout 14 is coupled to the container body 12.

As illustrated in FIGS. 1 and 2, the ink bottle 10 includes a container body 12 that can hold an ink composition L therein, a spout 14 configured to be coupled to the container body 12, and a seal 16 configured to be attached to the container body 12.

Preferably, the ink bottle 10 is stored in the “storage position” illustrated in FIGS. 1 and 2, i.e., with the spout 14 and the seal 16 at the vertically upper end (distal end) of the container body 12. The directions mentioned hereinafter are those based on an ink bottle in this storage position. When the receiver of the ink composition L in the ink bottle 10, such as an ink tank, is refilled, the ink bottle 10 is tilted from the storage position to let the ink composition L fall down. The position of the ink bottle 10 in which the spout 14 is at the vertically lower end of the container body 12 may be referred to as the “refill position” herein.

The container body 12 has a bottomed cylindrical storage section 22, which forms a storage compartment 21 that can hold an ink composition L therein, and also has a cylindrical neck 23, which has a smaller diameter than the storage section 22. The neck 23 is at the distal end of the storage section 22, with a first male thread 24 winding around its outer circumference. The bottomed cylinder, illustrated in the drawings, is not the only possible shape of the storage section 22. The container body 12 may be shaped like a bag flexible in shape so that the storage section 22 can deform. The storage section 22, furthermore, does not need to be substantially cylindrical.

More preferably, the container body 12 is a rigid or semi-rigid container. A rigid container is one that hardly deforms when handled manually by the user, whereas a semi-rigid container is one that can deform when handled manually by the user but returns to its original shape.

The ink bottle 10 contains a substance having a thermal conductivity of 0.29 W/mK or less. To be more specific, at least the components of the ink bottle 10 that can be touched by the ink composition L is made of a substance having a thermal conductivity of 0.29 W/mK or less. These components include the storage section 22 of the container body 12.

As a general trend, materials containing a substance having a thermal conductivity of 0.29 W/mK or less conduct less heat than those containing a substance having a thermal conductivity of more than 0.29 W/mK.

Examples of such materials include plastics. It is particularly preferred to use polypropylene, polycarbonate, or polyethylene terephthalate. These materials are inexpensive and readily available.

The container body 12 may have a multilayer structure but is made of a material that contains a substance having a thermal conductivity of 0.29 W/mK or less. The thermal conductivity of a material can be measured according to, for example, ISO/CD 22007-2.

In this ink bottle 10, an ink composition L is more stable when stored. To be more specific, colorants having a coumarin backbone separate out easily, but even when an ink composition L containing such a colorant is placed in a situation involving exposure to heat, such as transportation, this ink bottle 10 conducts little heat to the ink composition L by virtue of the thermal conductivity of the substance therein that is equal to or smaller than a particular limit. The formation of contaminants, therefore, is limited, hence improved storage stability.

Because the storage section 22 is made of a substance having a thermal conductivity of 0.29 W/mK or less, the storage stability of the ink composition L in the ink bottle 10 is sufficiently high. Preferably, the thickness between the inner surface and the outer surface, which is exposed to the environment, of the storage section 22 is 200 μm or more, more preferably 1000 μm or more. This further reduces the amount of heat transmitted to the ink composition L contained in the ink bottle 10, thereby helping further improve the storage stability of the ink composition L.

Preferably, the storage section 22 has a surface roughness of 40 rsm or more on its inner surface 27. For higher storage stability of the ink composition L, it is more preferred that the surface roughness be 100 rsm or more. The surface roughness of a material can be measured according to, for example, ISO 25178. This helps reduce the production of contaminants. In that case the ink composition L flows better at the interface where it touches the inside of the ink bottle 10, and the improved fluidity allows ingredients in the ink composition L, which will be exposed to heat, to disperse well.

Preferably, the volume of the ink composition L contained in the storage section 22 is 100 ml or more. In other words, it is preferred that the ink bottle 10 can hold 100 ml or more of ink composition L therein. This helps limit the formation of contaminants. In that case the volume of the ink composition L contained is relatively large. As well as it takes a long time for heat to spread throughout such a volume of ink composition L, the heat is dispersed and, therefore, does not spread throughout the ink composition L easily.

The spout 14 has an outlet 26 through which the ink composition L in the storage compartment 21 can flow out. The spout 14 discharges the ink composition L from its outlet 26 when it is coupled to the container body 12 with the seal 16 off and then the ink bottle 10 is inverted to the position opposite the storage position in the vertical direction.

As illustrated in FIG. 2, the spout 14 has a wide portion 29 and a narrow portion 30. When the spout 14 is attached to the container body 12, the former comes closer to the outer circumference of the neck 23, whereas the latter comes farther away from the container body 12 and forms the outlet 26. Around the inner circumference of the wide portion 29 is a first female thread 31, which engages with the first male thread 24. The spout 14 is attached to the distal end of the container body 12 by screwing the first female thread 31 into the first male thread 24.

The outlet 26 of the spout 14 can have any shape. For example, it may be formed to fit the shape of the receiver of the ink composition L, such as an ink tank of a printer. The ink bottle 10 may have a gasket that makes the inside more airtight when the spout 14 and the container body 12 are coupled together. The ink bottle 10, furthermore, may have a mechanism or shape that allows the spout 14 and the container body 12 to slide on or come into close contact with each other.

With respect to the spout 14 and the seal 16, it is preferred that the ink bottle 10 have a cap that seals the storage section 22 against the environment and is detachable. This helps prevent water and organic solvents from evaporating. The use of a detachable cap, in particular, makes the ink bottle 10 more useful as it allows the user to store the bottle with remaining ink composition inside when not using all.

The ink bottle 10 has a seal 16 at the opening of the container body 12, or has a seal 16 at the distal end of the neck 23 of the container body 12. The seal 16 provides an airtight seal of the ink composition L in the storage section 22 of the container body 12. The seal 16 and the container body 12 are bonded together, for example with an adhesive. Alternatively, the seal 16 and the container body 12 may be bonded together by heat sealing.

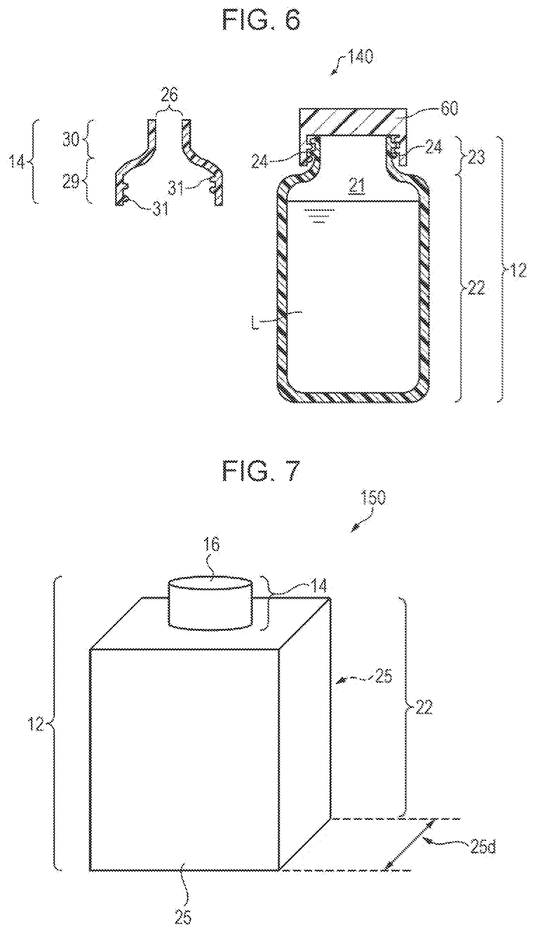

More preferably, the seal 16 and the container body 12 are bonded together in such a manner that the user can remove the seal 16 by pulling it by hand. Alternatively, the seal 16 may be configured such that the user can open it by breaking through it. The seal 16 may be in the form of a rigid screw cap (see FIG. 6) or stopper (not illustrated), and a gasket, for example, may optionally be used to keep the storage compartment 21 airtight.

As can be seen from this, the construction of the seal 16, such as its shape and the substance(s) forming it, is not critical as long as the storage compartment 21 can be kept airtight. For the ease of handling, production cost, and other reasons, however, it is more preferred that the seal 16 be made with a film.

The ink bottle 10 may contain an ink composition L and gas. The gas is usually air, but the air may be replaced with an inert gas, such as nitrogen or argon. The gas may contain volatile components from the ink composition L.

The ink bottle 10 has many variations. FIGS. 3 to 7 are schematic cross-sectional or perspective views of ink bottles 110 to 150, respectively, as alternative forms of the ink bottle 10 according to this embodiment (hereinafter also referred to as alternative ink bottles). Those elements of the alternative ink bottles 110 to 150 that operate or function in the same way as those of the ink bottle 10 are not described in detail; they are given the same numerals as those of the ink bottle 10.

The alternative ink bottle 110 illustrated in FIG. 3 includes a container body 12 that can hold an ink composition L therein, a spout 14 configured to be coupled to the container body 12, and a seal 16 configured to be attached to the spout 14. The ink bottle 110 differs from the above ink bottle 10 in that the seal 16 is attached to the spout 14. The ink bottle 110 also has a gasket 40 for keeping the joint between the container body 12 and the spout 14 airtight.

The ink bottle 110 can hold more ink composition L because it can contain an ink composition L up to the capacity of the storage compartment 21 of the container body 12 plus inside the spout 14. A greater ink composition L capacity helps limit the formation of contaminants. As well as it takes a longer time for heat to spread throughout the ink composition L, the heat is dispersed and, therefore, does not spread throughout the ink composition L easily. Preferably, the container body 12 and the spout 14 are kept coupled while the ink bottle 110 is transported, stored, or used.

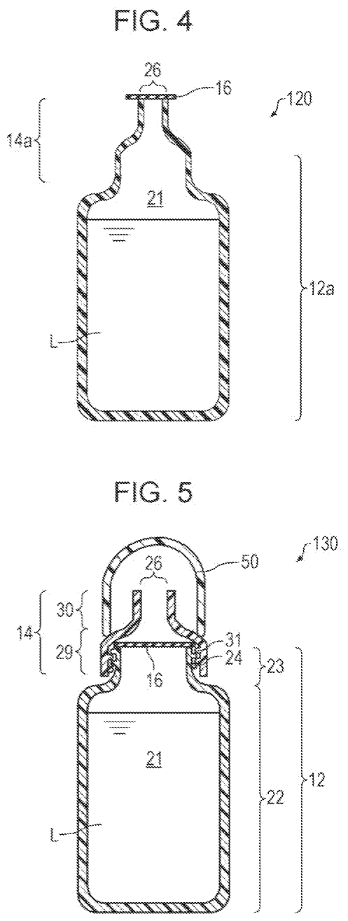

The alternative ink bottle 120 illustrated in FIG. 4 is a one-piece unit having a portion 12a corresponding to the container body 12 and a portion 14a corresponding to the spout 14. The ink bottle 120 also includes a seal 16 attached to the portion 14a corresponding to the spout 14. The ink bottle 120 differs from the above ink bottle 110 in that the container body 12a and the spout 14a are integrated with each other.

The alternative ink bottle 130 illustrated in FIG. 5 includes a container body 12 that can hold an ink composition L therein, a spout 14 configured to be coupled to the container body 12, and a seal 16 configured to be attached to the container body 12. Besides these, the ink bottle 130 includes a cap 50 that closes the outlet 26 of the spout 14. The ink bottle 130 differs from the above ink bottle 10 in that it has the cap 50. The cap 50 is detachable from the spout 14. By attaching the cap 50 to the spout 14, the storage section 22 can be sealed against the environment even without the seal 16.

For the ink bottle 130, the outlet 26 of the spout 14 can be mechanically protected by attaching the cap 50. Attaching the cap 50 will also help prevent the spout 14 from being contaminated.

The alternative ink bottle 140 illustrated in FIG. 6 includes a container body 12 that can hold an ink composition L therein, a spout 14 configured to be coupled to the container body 12, and a seal 60 configured to be attached to the container body 12. The ink bottle 140 differs from the above ink bottle 10 in that the seal 60 is not in film form but is a rigid screw cap.

The ink bottle 140 includes a container body 12 that engages with the spout 14 and also includes a seal 60 configured to seal the space, in the container body 12, for holding an ink composition L in. That is, the combination of the spout 14 and the container body 12 sealed by the seal 60 with an ink composition L inside can be an ink bottle kit. Such a kit allows, for example, the spout 14 to be reused and helps reduce the cost for transporting the ink composition L.

It should be noted that the above ink bottles 10 and 130 can also be a component of an ink bottle kit like the ink bottle 140 as they have the seal 16 on the container body 12 side.

The alternative ink bottle 150 illustrated in FIG. 7 includes a container body 12 that can hold an ink composition L therein, a spout 14 configured to be coupled to the container body 12, and a seal 16 configured to be attached to the spout 14. The ink bottle 150 differs from the above ink bottle 110 in that its storage section 22 has a pair of outer surfaces facing each other.

With regard to the external shape of its container body 12, the ink bottle 150 has a pair of outer surfaces 25 facing each other. The distance 25d between the pair of outer surfaces 25 is 3.5 cm or less. By virtue of this, the ink bottle 150 is more advantageous in terms of convenience as it can be sent easily, for example by posting it into a public mailbox. Although it can be hot inside a mailbox depending on where the box is, ink bottles according to this embodiment conduct little heat to the ink composition L contained therein. Even when the ink bottle 150 is posted into a mailbox hot inside, therefore, the formation of contaminants therein is limited.

### 2. Ink Jet Ink Composition

The ink composition L in this embodiment contains at least one colorant having a coumarin structure and also contains water.

### 2.1. Colorant having a Coumarin Structure

Of colorants, those having a coumarin structure are particularly apt to produce contaminants when exposed to heat. In more specific terms, a colorant having a coumarin structure in a water-based ink composition L, in which water is the primary solvent, hydrolyzes by touching the water. The hydrolysates, the inventors believe, are a source of contaminants.

The colorant in this aspect of the disclosure can be of any kind as long as it has a coumarin structure, but examples include dyes having a coumarin structure and organic pigments having a coumarin structure. Of these, dyes are particularly preferred, and disperse dyes are more preferred. In this embodiment, a “colorant having a coumarin structure” can be any colorant that has a coumarin backbone. For example, it may be a compound (colorant) in which at least one hydrogen atom in the coumarin structure has been replaced with a non-hydrogen atom or a group of atoms. One colorant having a coumarin structure may be used alone, or two or more may be used in combination.

Examples of dyes include acid dyes having a coumarin structure, such as C.I. (colour index generic name) Acid Yellow, C.I. Acid Red, C.I. Acid Blue, C.I. Acid Orange, C.I. Acid Violet, and C.I. Acid Black; basic dyes having a coumarin structure, such as C.I. Basic Yellow, C.I. Basic Red, C.I. Basic Blue, C.I. Basic Orange, C.I. Basic Violet, and C.I. Basic Black; direct dyes having a coumarin structure, such as C.I. Direct Yellow, C.I. Direct Red, C.I. Direct Blue, C.I. Direct Orange, C.I. Direct Violet, and C.I. Direct Black; reactive dyes having a coumarin structure, such as C.I. Reactive Yellow, C.I. Reactive Red, C.I. Reactive Blue, C.I. Reactive Orange, C.I. Reactive Violet, and C.I. Reactive Black; and disperse dyes having a coumarin structure, such as C.I. Disperse Yellow, C.I. Disperse Red, C.I. Disperse Blue, C.I. Disperse Orange, C.I. Disperse Violet, and C.I. Disperse Black.

Of these, disperse dyes are particularly preferred, and so are acid dyes and basic dyes, for example, which are not disperse dyes but are sparingly soluble in water and dispersed in making a water-based ink therewith. Of these, sublimation dyes are more preferred than others. In this context, a “sublimation dye” refers to a dye that sublimates when heated. More specific examples of sublimation dyes include C.I. Disperse Yellow 82, C.I. Disperse Yellow 232, and C.I. Acid Yellow 184. Of these, it is particularly preferred to use C.I. Disperse Yellow 82 and/or C.I. Disperse Yellow 232. This helps improve the saturation of yellow when the ink composition L is applied to a medium, such as an intermediate transfer medium or substrate for dyeing.

Preferably, the percentage of the colorant having a coumarin structure is 0.05% by mass or more and 20% by mass or less of the total amount of the ink composition L. This makes the advantages of this embodiment greater and more consistent.

In this embodiment, the ink composition L may contain other colorant(s) unless it impairs the advantages of this aspect of the disclosure.

The colorant having a coumarin structure may be dispersed in the ink composition L using a dispersant. The dispersant can be a known one.

### 2.2. Water

The water is, for example, purified water, such as deionized water, ultrafiltered water, reverse osmosis water, or distilled water, or ultrapure water.

Colorants in a coumarin structure and colorants that are disperse dyes tend to be inferior in storage stability when the water content is small. It is, therefore, preferred that the water content be 30% by mass or more and 80% by mass or less of the total amount of the ink composition L. This makes the advantages of this embodiment greater and more consistent.

### 2.3. Water-Soluble Organic Solvent

The ink composition L may contain a water-soluble organic solvent. Examples of water-soluble organic solvents include glycerol; glycols, such as ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-hexanediol, and 1,6-hexanediol; glycol monoethers, such as ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, and triethylene glycol monomethyl ether; nitrogen-containing solvents, such as 2-pyrrolidone, N-methyl-2-pyrrolidone, and N-ethyl-2-pyrrolidone; and alcohols, such as methanol, ethanol, n-propyl alcohol, isopropyl alcohol, n-butanol, 2-butanol, tert-butanol, isobutanol, n-pentanol, 2-pentanol, 3-pentanol, and tert-pentanol. One such water-soluble organic solvent may be used alone, or two or more may be used in combination.

Preferably, the percentage of the water-soluble organic solvent(s) is 10% by mass or more and 30% by mass or less of the total amount of the ink composition L. This makes the advantages of this embodiment greater and more consistent.

### 2.4. Surfactant

The ink composition L may contain a surfactant. Examples of surfactants include acetylene glycol surfactants, fluorosurfactants, and silicone surfactants. One surfactant may be used alone, or two or more may be used in combination.

Examples of acetylene glycol surfactants include 2,4,7,9-tetramethyl-5-decin-4,7-diol and their alkylene oxide adducts and 2,4-dimethyl-5-decin-4-ol and their alkylene oxide adducts.

Commercially available acetylene glycol surfactants can also be used. Examples include OLFINE® 104 and E surfactants (trade names, Nissin Chemical Industry Co., Ltd.); and Surfynol® surfactants (trade names, Air Products and Chemicals, Inc.).

Examples of fluorosurfactants include perfluoroalkyl sulfonates, perfluoroalkyl carboxylates, perfluoroalkyl phosphates, perfluoroalkyl ethylene oxide adducts, perfluoroalkyl betaines, and perfluoroalkyl amine oxide compounds. Commercially available fluorosurfactants can also be used. Examples include S-144 and S-145 (trade names, Asahi Glass Co., Ltd.).

Examples of silicone surfactants include polysiloxane compounds and polyether-modified organosiloxanes. Commercially available silicone surfactants can also be used. Examples include BYK-306, BYK-307, BYK-333, BYK-341, BYK-345, BYK-346, BYK-347, BYK-348, and BYK-349 (trade names, BYK Japan KK).

Preferably, the surfactant content is 0.5% by mass or more and 5.0% by mass or less of the total amount of the ink composition L. This makes the advantages of this embodiment greater and more consistent.

### 2.5. Other Ingredients

The ink composition L may contain additives, such as solubilizers, viscosity modifiers, pH-adjusting agents, antioxidants, preservatives, antimolds, anticorrosives, and chelating agents for capturing metal ions that would affect dispersion. One additive may be used alone, or two or more may be used in combination.

The percentage of the additive(s) is not critical. Approximately, however, the percentage of each additive is 0.01% by mass or more and 5.0% by mass of the total amount of the ink composition L. 3. Applications of the Ink Jet Ink Composition

An aspect of the present disclosure provides good storage stability even when heated and prevents poor ejection caused by contamination. The ink composition L, therefore, is more effective when made with disperse dye(s), which is more likely than pigments and other dyes to produce contaminants when heated. This means dyeing using sublimation transfer is a suitable application. An example of a dyeing process in which sublimation transfer is used is ink jet printing on a sheet-shaped transfer medium, such as paper, using an ink jet recording apparatus combined with subsequent sublimation transfer by heating this transfer medium on a recording medium, such as fabric.

### 3.1. Ink Jet Recording Method

An ink jet recording method that is a process of dyeing using sublimation transfer includes attaching an ink composition L to a recording side of a first recording medium; placing a second recording medium on the recording side of the first recording medium; and heating the first and second recording media. In other words, a sublimation-transfer ink jet recording method includes an ink application step, in which an ink composition L is applied to an intermediate transfer medium using ink jet technology; and a transfer step, in which a disperse dye is transferred to a substrate for dyeing by heating the intermediate transfer medium with the applied ink composition L thereon with its side carrying the ink composition L facing a dyeing side of the substrate for dyeing. This is a highly productive way of producing a dyed article, which means this sublimation-transfer ink jet recording method can also be described as a method for producing a dyed article. The following describes this method in detail.

### 3.2. Ink Application Step

An ink composition L is applied to a recording side of an intermediate transfer medium, which is a first recording medium, using ink jet technology. The ink jet ejection of the ink composition L can be done using an apparatus that ejects droplets. An example of an apparatus that ejects droplets is the aforementioned ink jet recording apparatus.

In ejecting droplets by ink jet technology, examples of techniques that can be used include piezoelectric ejection and ejecting the ink composition L using bubbles produced by heating the ink composition L. Of these, piezoelectric ejection is preferred, for example because of low risk of denaturing the ink composition L.

The intermediate transfer medium can be, for example, paper, such as ordinary printing paper, or a recording medium having an ink-receiving layer. Recording media having an ink-receiving layer are called ink jet paper, coated paper, etc. When selected from these, paper having an ink-receiving layer that contains inorganic particles, for example of silica, is more preferred than others. Using it will help prevent bleeding, for example, on the recording side of the intermediate recording medium that can occur when the ink composition L applied to the intermediate transfer medium dries. Such a medium, furthermore, makes the sublimation of a disperse dye in the subsequent transfer step more efficient as it will hold the disperse dye on the surface of its recording side even more firmly than others would.

The use of multiple ink compositions is allowed. It helps, for example, expand the color gamut of the process. One of the multiple ink compositions may be an ink composition L according to this embodiment, or two or more may be ink compositions L according to this embodiment.

### 3.3. Transfer Step

Then a disperse dye in the ink composition L is transferred to a substrate for dyeing by heating the intermediate transfer medium with the applied ink composition(s) L thereon with its recording side facing the substrate for dyeing, or with a second recording medium placed on the recording side of the first recording medium. This gives a dyed article having a transferred disperse dye thereon.

The manufacturer only needs to heat the intermediate transfer medium with the applied ink composition(s) L thereon with the medium facing the substrate for dyeing. More preferably, the intermediate transfer medium and the substrate for dyeing are in tight contact with each other when the transfer medium is heated. This helps, for example, make the image recorded on the second recording medium more vivid, or dye the recording medium more vividly.

Sheet-shaped substrates, such as fabric, for example of hydrophobic fibers, and resin films and plastic films, are suitable for use as the substrate for dyeing, but substrates not shaped like a sheet but having a spherical, cubic, or other three-dimensional shape may also be used.

The substrate for dyeing, furthermore, does not need to be, for example, a resin or plastic one, but may be a piece of glass, metal, or ceramic. When the substrate for dyeing is fabric, examples of textile fibers that can be used include polyester fiber, nylon fiber, triacetate fiber, diacetate fiber, polyamide fiber, and blends of two or more of these fibers. Blends of these fibers with a regenerated fiber, such as rayon, or with a natural fiber, such as cotton, silk, or wool, may also be used.

When the substrate for dyeing is a resin or plastic film, furthermore, examples of them include a polyester film, a polyurethane film, a polycarbonate film, a polyphenylene sulfide film, a polyimide film, and a polyamide imide film. Such a film may be a multilayer film, i.e., a stack of multiple layers, or may be one made from a compositionally graded material, a material in which the composition varies gradually.

The recording medium including fabric may be a piece of fabric itself, but preferably is a piece of fabric treated with a pretreatment solution containing resin particles. With a pretreatment of the fabric, the resulting recording tends to be better in fastness to rubbing.

### 4. Examples and Comparative Examples

The following describes an aspect of the present disclosure in detail by providing examples. No aspect of the disclosure, however, is limited to these examples. In the following, “parts” and “%” are by mass unless stated otherwise. The testing was performed under 25.0° C. and 40.0% RH conditions unless specified otherwise.

### 4.1. Preparation of Ink Jet Ink Compositions

Ink compositions according to examples and comparative examples were prepared using the colorants specified in Tables 1 and 2. The colorant and other ingredients, such as water, water-soluble organic solvents, and a surfactant, were put into a container to make the total 100% by mass, mixed and stirred for 2 hours using a magnetic stirrer, and then fully mixed together by dispersion with 0.3-mm zirconia beads in a bead mill. After 1 hour of stirring, the mixture was filtered through a 5.0-μm PTFE membrane filter to give an ink composition.

### 4.2. Ink Bottles

Tables 1 and 2 present the substance used to make the container body and its thermal conductivity (W/mK) in the ink bottle of the example or comparative example. In the tables, “PP” represents polypropylene, “PE” represents polyethylene, “PC” represents polycarbonate, and “PET” represents polyethylene terephthalate.

TABLE 1

| | | Example 1 | Example 2 | Example 3 | Example 4 | Example 5 | Example 6 | Example 7 |
|---|---|---|---|---|---|---|---|---|
| Colorant | C.I. Disperse | 3.0 | — | — | — | 3.0 | 3.0 | 3.0 |
| | Yellow 82 | | | | | | | |
| | C.I. Disperse | — | 3.0 | — | — | — | — | — |
| | Yellow 232 | | | | | | | |
| | C.I. Disperse | — | — | 3.0 | — | — | — | — |
| | Yellow 184 | | | | | | | |
| | C.I. Disperse | — | — | — | 3.0 | — | — | — |
| | Yellow 242 | | | | | | | |
| Dispersant | Sodium salt of | 3.0 | 3.0 | 3.0 | 3.0 | 3.0 | 3.0 | 3.0 |
| | a naphthalene | | | | | | | |
| | sulfonate | | | | | | | |
| | formaldehyde | | | | | | | |
| | condensate | | | | | | | |
| Water-soluble | Glycerol | 15.0 | 15.0 | 15.0 | 15.0 | 15.0 | 15.0 | 15.0 |
| organic solvents | Propylene glycol | 10.0 | 10.0 | 10.0 | 10.0 | 10.0 | 10.0 | 10.0 |
| Surfactant | BYK348 | 0.5 | 0.5 | 0.5 | 0.5 | 0.5 | 0.5 | 0.5 |

| | | | | | | | |
|---|---|---|---|---|---|---|---|
| Water | Balance | Balance | Balance | Balance | Balance | Balance | Balance |
| Ink bottle substance | PP | PP | PP | PP | PC | PET | PP |
| Thermal conductivity (W/mK) by ink | 0.125 | 0.125 | 0.125 | 0.125 | 0.190 | 0.250 | 0.125 |
| bottle substance | | | | | | | |
| Ink bottle thickness (μm) | 1000 | 1000 | 1000 | 1000 | 1000 | 1000 | 100 |
| Ink composition volume (mL) | 150 | 150 | 150 | 150 | 150 | 150 | 150 |
| Ink bottle RSM roughness (nm) | 250 | 250 | 250 | 250 | 250 | 250 | 250 |
| Contamination (number of particles) | A | A | A | A | A | B | C |
| Precipitation | A | A | A | A | A | B | C |
| Color saturation | A | A | A | A | A | A | A |

| | | Example 8 | Example 9 | Example 10 | Example 11 | Example 12 |
|---|---|---|---|---|---|---|
| Colorant | C.I. Disperse | 3.0 | 3.0 | 3.0 | 3.0 | 3.0 |
| | Yellow 82 | | | | | |
| | C.I. Disperse | — | — | — | — | — |
| | Yellow 232 | | | | | |
| | C.I. Disperse | — | — | — | — | — |
| | Yellow 184 | | | | | |
| | C.I. Disperse | — | — | — | — | — |
| | Yellow 242 | | | | | |
| Dispersant | Sodium salt of | 3.0 | 3.0 | 3.0 | 3.0 | 3.0 |
| | a naphthalene | | | | | |
| | sulfonate | | | | | |
| | formaldehyde | | | | | |
| | condensate | | | | | |
| Water-soluble | Glycerol | 15.0 | 15.0 | 15.0 | 15.0 | 15.0 |
| organic solvents | Propylene glycol | 10.0 | 10.0 | 10.0 | 10.0 | 10.0 |
| Surfactant | BYK348 | 0.5 | 0.5 | 0.5 | 0.5 | 0.5 |

| | | | | | |
|---|---|---|---|---|---|
| Water | Balance | Balance | Balance | Balance | Balance |
| Ink bottle substance | PP | PP | PP | PP | PP |
| Thermal conductivity (W/mK) by ink | 0.125 | 0.125 | 0.125 | 0.125 | 0.125 |
| bottle substance | | | | | |
| Ink bottle thickness (μm) | 250 | 1000 | 1000 | 250 | 250 |
| Ink composition volume (mL) | 150 | 110 | 50 | 110 | 50 |
| Ink bottle RSM roughness (nm) | 250 | 250 | 250 | 250 | 250 |
| Contamination (number of particles) | B | B | B | B | C |
| Precipitation | B | B | B | B | C |
| Color saturation | A | A | A | A | A |

TABLE 2

| | | Example 13 | Example 14 | Example 15 | Example 16 | Example 17 | Example 18 |
|---|---|---|---|---|---|---|---|
| Colorant | C.I. Disperse | 3.0 | 3.0 | 3.0 | 3.0 | 3.0 | 3.0 |
| | Yellow 82 | | | | | | |
| | C.I. Disperse | — | — | — | — | — | — |
| | Yellow 54 | | | | | | |
| Dispersant | Sodium salt of | 3.0 | 3.0 | 3.0 | 3.0 | 3.0 | 3.0 |
| | a naphthalene | | | | | | |
| | sulfonate | | | | | | |
| | formaldehyde | | | | | | |
| | condensate | | | | | | |
| Water-soluble | Glycerol | 15.0 | 15.0 | 15.0 | 15.0 | 15.0 | 15.0 |
| organic solvents | Propylene glycol | 10.0 | 10.0 | 10.0 | 10.0 | 10.0 | 10.0 |
| Surfactant | BYK348 | 0.5 | 0.5 | 0.5 | 0.5 | 0.5 | 0.5 |
| Water | | Balance | Balance | Balance | Balance | Balance | Balance |
| Ink bottle substance | | PP | PP | PP | PP | PC | PC |
| Thermal conductivity (W/mK) by ink | | 0.125 | 0.125 | 0.125 | 0.125 | 0.190 | 0.190 |
| bottle substance | | | | | | | |
| Ink bottle thickness (μm) | | 100 | 100 | 1000 | 1000 | 1000 | 1000 |
| Ink composition volume (mL) | | 110 | 50 | 150 | 150 | 150 | 150 |
| Ink bottle RSM roughness (nm) | | 250 | 250 | 50 | 35 | 50 | 35 |
| Contamination (number of particles) | | C | C | B | C | B | C |
| Precipitation | | C | C | B | C | B | C |
| Color saturation | | A | A | A | A | A | A |
| | | Comparative | Comparative | Comparative | Comparative | Comparative | Comparative |
| | | Example 1 | Example 2 | Example 3 | Example 4 | Example 5 | Example 6 |
| Colorant | C.I. Disperse | — | — | 3.0 | 3.0 | — | 3.0 |
| | Yellow 82 | | | | | | |
| | C.I. Disperse | 3.0 | 3.0 | — | — | 3.0 | — |
| | Yellow 54 | | | | | | |
| Dispersant | Sodium salt of | 3.0 | 3.0 | 3.0 | 3.0 | 3.0 | 3.0 |
| | a naphthalene | | | | | | |
| | sulfonate | | | | | | |
| | formaldehyde | | | | | | |
| | condensate | | | | | | |
| Water-soluble | Glycerol | 15.0 | 15.0 | 15.0 | 15.0 | 15.0 | 15.0 |
| organic solvents | Propylene glycol | 10.0 | 10.0 | 10.0 | 10.0 | 10.0 | 10.0 |
| Surfactant | BYK348 | 0.5 | 0.5 | 0.5 | 0.5 | 0.5 | 0.5 |

| | | | | | | |
|---|---|---|---|---|---|---|
| Water | Balance | Balance | Balance | Balance | Balance | Balance |
| Ink bottle substance | PP | PE | PE | Glass | PP | PE |
| Thermal conductivity (W/mK) by ink | 0.125 | 0.3-0.5 | 0.3-0.5 | 0.75-0.95 | 0.125 | 0.3-0.5 |
| bottle substance | | | | | | |
| Ink bottle thickness (μm) | 1000 | 1000 | 1000 | 1000 | 100 | 100 |
| Ink composition volume (mL) | 150 | 150 | 150 | 150 | 150 | 150 |
| Ink bottle RSM roughness (nm) | 250 | 250 | 250 | 250 | 250 | 250 |
| Contamination (number of particles) | A | A | D | D | A | E |
| Precipitation | A | A | D | D | A | E |
| Color saturation | D | D | A | A | E | A |

### 4.3. Testing

In each category of testing, the test specimens were subjected to heat conditions in advance as follows. That is, ink bottles of the examples and comparative examples were made by filling an empty ink bottle shaped like that in FIG. 2 with 100 mL of the ink composition. Then the ink bottles were left in the storage position for 2 weeks under 40° C. and 20% RH conditions.

### 4.4. Storage Stability

The ink bottles of the examples and comparative examples were tested for contamination, a measure of storage stability, through a filter clogging test as follows. The ink composition was transferred from the ink bottle into an ink jet printer (PX-G930, Seiko Epson). To be more specific, 100 mL of the ink composition in the ink bottle was supplied from the ink bottle to the recording head via a subtank installed inside the printer. After the ink composition was ejected from the recording head, the filter (stainless steel; mesh hole size, 3.5 μm) in the feeding tube between the ink bottle and the subtank was examined for how much it clogged.

The extent of clogging of the filter was determined by counting contaminant particles trapped on the surface of the filter using VHX-900 digital microscope (Keyence). The degree of contamination was graded by the number of particles according to the criteria below. The results are presented in the tables.

A: No particle is observed; mild contamination.

B: The number of particles is 1 or more and less than 10; mild contamination.

C: The number of particles is 10 or more and less than 20; mild contamination.

D: The number of particles is 20 or more and less than 50; severe contamination.

E: The number of particles is 50 or more; severe contamination.

### 4.5. Precipitation

A volume of the ink composition was put into a centrifuge tube to make the total mass of the tube, its lid, and the ink composition 55 g, and the tube was closed with the lid. This closed tube was placed in a centrifuge (Hitachi Koki Co., Ltd.'s model “CR-20B2,” rotor no. 36) and processed at a speed of 10000 rpm for 15 minutes, and the supernatant (5-g region from the gas-liquid interface) was sampled. The absorption of light at the peak wavelength of the ink composition was measured in this supernatant and in the unprocessed ink composition. The degree of precipitation was graded by the percentage of the absorption by the supernatant to that by the ink composition according to the criteria below.

A: The concentration of the supernatant is 95% or more of the initial concentration; mild precipitation.

B: The concentration of the supernatant is 90% or more and less than 95% of the initial concentration; mild precipitation.

C: The concentration of the supernatant is 85% or more and less than 90% of the initial concentration; mild precipitation.

D: The concentration of the supernatant is 80% or more and less than 85% of the initial concentration; severe precipitation.

E: The concentration of the supernatant is less than 80% of the initial concentration; severe precipitation.

### 4.6. Saturation

Using the ink composition, a solid pattern was printed on a sheet of transfer paper, which was an intermediate transfer medium, using an ink jet printer (PX-G930, Seiko Epson). This sheet of transfer paper was laid over a piece of polyester cloth with the side carrying the attached ink facing the cloth, and then, by heating the paper at 200° C. for 60 seconds using Taiyo-Seiki Co., Ltd.'s TP-600A2 transfer press, the pattern was transferred from it to the polyester cloth by sublimation transfer. In such a way, a fabric sample for testing was obtained.

The dyed cloth for testing was graded for saturation, a measure of color strength, by measuring the reflection density of yellow, or DY, using GretagMacbeth's Spectrolino (trade name) colorimeter.

A: The density of yellow is 1.5 or more; strong yellow.

B: The density of yellow is 1.2 or more and less than 1.5; strong yellow.

C: The density of yellow is 1.0 or more and less than 1.2; strong yellow.

D: The density of yellow is 0.8 or more and less than 1.0; weak yellow.

E: The density of yellow is less than 0.8; weak yellow.

### 4.7. Test Results

In the ink bottles of the Examples, the formation of contaminants was mild compared with those of the Comparative Examples. In Comparative Examples 1, 2, and 5, in which the colorant did not have a coumarin backbone, saturation was low compared with Examples 1 to 4, in which the colorant had a coumarin backbone.

Comparing Example 1 with Examples 5 and 6 reveals that the presence of a substance having a thermal conductivity of 0.29 W/mK or less reduces the formation of contaminants. Comparing Example 1 with Comparative Examples 3, 4, and 6, furthermore, reveals that contamination is severe when no such substance is contained.

Comparing Example 1 with Examples 7 and 8 reveals the formation of contaminants is further reduced when the thickness of the ink bottle is in a particular range.

Comparing Example 1 with Examples 9 and 10 reveals that the formation of contaminants is further reduced when the volume of the ink composition contained is in a particular range. The same is also true when Example 8 is compared with Examples 11 and 12 or when Example 7 is compared with Examples 13 and 14.

Comparing Example 1 with Examples 15 and 16 reveals that the formation of contaminants is further reduced when the roughness of the inner surface of the ink bottle is in a particular range. The same is also true when Example 5 is compared with Examples 17 and 18.

As well as providing the advantage of reduced contamination, an aspect of the present disclosure also demonstrated its secondary advantage in the precipitation testing. Precipitation was reduced more greatly with increasing reduction in contamination, presumably because the particles of the dye grew only to a limited extent by virtue of reduced formation of contaminants. The precipitation grades followed exactly the same trend as the contamination grades.

What is claimed is:

1. An ink package comprising:
an ink jet ink composition; and
a storage section containing the ink jet ink composition, wherein:
the ink package contains a substance having a thermal conductivity of 0.29 W/mK or less; and
the ink jet ink composition contains at least one colorant having a coumarin backbone and also contains water.

2. The ink package according to claim 1, wherein:
a thickness between an inner surface, which faces the ink jet ink composition, and an outer surface, which is exposed to environment, of the storage section is 200 μm or more.

3. The ink package according to claim 2, wherein:
a volume of the ink jet ink composition contained is 100 ml or more.

4. The ink package according to claim 2, wherein:
a roughness of the inner surface is 40 rsm or more.

5. The ink package according to claim 1, wherein:
the substance is one of polypropylene, polyethylene terephthalate, or polycarbonate.

6. The ink package according to claim 2, further comprising:
a cap that seals the storage section against the environment and is detachable.

7. The ink package according to claim 1, wherein:
with regard to an external shape, the ink package has a pair of outer surfaces facing each other; and
a distance between the pair of outer surfaces is 3.5 cm or less.

8. The ink package according to claim 1, wherein:
the colorant is one or more of C.I. Disperse Yellow 82 or C.I. Disperse Yellow 232.
